(19) United States
(12) Patent Application Publication
(10) Pub. No.: US 2011/0197219 A1
(43) Pub. Date: Aug. 11, 2011

(54) WIRELESS VIDEO DISTRIBUTION

(75) Inventor: Kevin Ross, Sunnyvale, CA (US)

(73) Assignee: NXP B.V., Eindhoven (NL)

(21) Appl. No.: 13/057,799

(22) PCT Filed: Aug. 4, 2009
(86) PCT No.: PCT/IB09/53392

§ 371 Date: Apr. 28, 2011

(30) Foreign Application Priority Data
Aug. 6, 2008 (US) 61086670
Aug. 4, 2009 (IB) PCT/IB2009/053392

(51) Int. Cl. H04N 7/167; H04N 7/173

(52) U.S. Cl. 725/31; 725/110

(57) ABSTRACT

Video data is communicated wirelessly. In accordance with various example embodiments, a wireless video communications system and approach involves communicating video from a server to clients over an ad-hoc wireless network that is implemented for relatively high bandwidth transmission (e.g., as may be amenable for use with high-definition video). In particular example embodiments, this approach is implemented for distributing video-services data such as that received in connection with a satellite or cable television services.

The present invention relates generally to video distribution systems, and to systems and methods for providing wireless video distribution in an ad-hoc wireless environment.

Video distribution in closed environments, and particularly in home environments, has grown in popularity and use. Cable, satellite, Internet and other types of video and television sources continue to grow in popularity and complexity. Many homeowners own multiple video display devices such as televisions, video monitors and computer monitors. In addition to these types of display devices, the use of hand-held devices that can display video has also increased.

Video distribution approaches have largely relied upon wired connections that require some sort of physical connection to video display devices in order to provide video thereto. In many applications, a service provider's signal is provided directly to a video display device, where the signal is processed and used to provide television or other video. For instance, cable or satellite service providers often use coaxial cable to provide a signal, either from a cable utility source or a satellite receiver located at a premises, to a set-top box (e.g., a physical box or video processing circuit) that processes the signal in order to provide video and audio outputs. Users select television or video programs via interaction with the set-top box.

Generally, set-top boxes as described above have been complex and relatively expensive for consumers and service providers who offer the boxes at reduced or free prices in order to secure a service agreement. Each box must have relatively complex and expensive functionality in order to process incoming signals, such as by decompressing, decrypting and/or otherwise processing an incoming signal to make the signal usable by a video display device. Some boxes also have video recording capabilities, which also adds to their complexity and cost.

In many applications, two or more video display devices are used in a common environment. For instance, many homeowners have one or more televisions in addition to a main television in a common viewing area. Bedrooms, kitchens and even outdoor patios are increasingly used as television viewing areas. These applications have been relatively expensive to implement, from both an equipment and connectivity vantage point. For instance, where a set-top box is required at each viewing location in a home, the homeowner and/or service provider must incur the cost of the additional box for each location. Connecting to these additional boxes can also be expensive, requiring connection cable and labor to install the cable. In retrofit applications involving existing structures, connecting cable to two or more viewing locations can be very difficult and time-consuming

Recently, wireless communications have been used to facilitate the communication of video to remote viewing locations within a particular environment, such as a home. However, these approaches have often been limited in their ability to deliver consistent, quality video, and have also been limited in bandwidth, which can be particularly challenging to the distribution of high-definition video. In addition, previous video-distribution approaches generally require relatively expensive equipment for sending and receiving video signals, and also for creating a wireless network environment in which the signals can be passed safely and securely. Wireless communications can also be difficult to set up and implement, and can require a skill level that is beyond that of many users. Relative to the above-discussed approaches to distributing service signals such as cable or satellite television signals, issues remain with regard to requirements involving compression, encryption, channel extraction and other functionality needed for the control and operation of set-top boxes.

These and other issues remain challenging to the implementation and use of video distribution applications, and in particular to service provider-type applications such as cable and satellite television distribution in a home environment.

Various aspects of the present invention are directed to methods and systems for distributing video in a manner that addresses challenges including those discussed above.

Example embodiments of the present invention are directed to a video distribution approach that involves wirelessly communicating high-definition video data directly from a server to a client using a robust protocol, such as provided in IEEE 802.11n, with ad-hoc wireless communications.

According to another example embodiment, a video distribution system provides direct server-client streaming of high-bandwidth video data over a wireless ad-hoc network. The system includes a server and a plurality of clients. Each client includes a transmitter to transmit video request data directly to the server on the network in accordance with an ad-hoc communications protocol, and a plurality of receivers to receive streaming video over the network. A microcontroller controls communications via the transmitter and receivers in accordance with an ad-hoc, high-bandwidth protocol. A video output circuit outputs, to a display device, video corresponding to the received video stream. The server includes a receiver to receive video request data directly from the clients, a video processing circuit to access video in response to video request data from the clients, and a plurality of transmitters to stream accessed video over the network and directly to one of the clients requesting the accessed video. A microcontroller controls communications via the receiver and transmitters in accordance with an ad-hoc, high-bandwidth protocol.

Another example embodiment is directed to a video services distribution system for direct, server-client streaming of video data over a wireless ad-hoc network. The system includes a server arrangement and a plurality of clients that can be implemented economically using an asymmetric wireless chipset (e.g., with a single transmitter and multiple receivers). Each client includes a transmitter to transmit video services request data directly to a video server on the network in accordance with an ad-hoc communications protocol, a plurality of receivers to receive streaming video services data over the network, and a microcontroller programmed to control communications via the transmitter and receivers in accordance with an ad-hoc, high-bandwidth protocol. Each client also includes a video output circuit to output, to a display device, high-definition video corresponding to the received video stream. The server arrangement includes a receiver to receive video services request data directly from the clients, and a video processing circuit to access and process video content from a video service provider, in response to video request data from the clients. The server arrangement also includes a plurality of transmitters to stream the accessed and processed video content over the network and directly to one of the clients requesting the accessed video content. A microcontroller is programmed to control communications via the server's receiver and transmitters in accordance with an ad-hoc, high-bandwidth protocol.

Other example embodiments are directed to programming approaches for programming a system, such as described above, for ad-hoc streaming of high-bandwidth video data directly from server to client. In some applications, such an approach involves reprogramming an existing wireless networking chip set to operate in accordance with a hybrid wireless protocol.

Certain example embodiments of the present invention are directed to ad-hoc video distribution systems that include video displays, a client receiver at each display and a media server that wirelessly distributes media services to the client receivers, using an approach such as described above.

In connection with other example embodiments of the present invention, methods for using a video distribution system involve communicating high-bandwidth video data directly from server to client over an ad-hoc wireless network.

The above summary is not intended to describe each embodiment or every implementation of the present disclosure. The figures and detailed description that follow more particularly exemplify various embodiments.

The invention may be more completely understood in consideration of the following detailed description of various embodiments of the invention in connection with the accompanying drawings, in which:

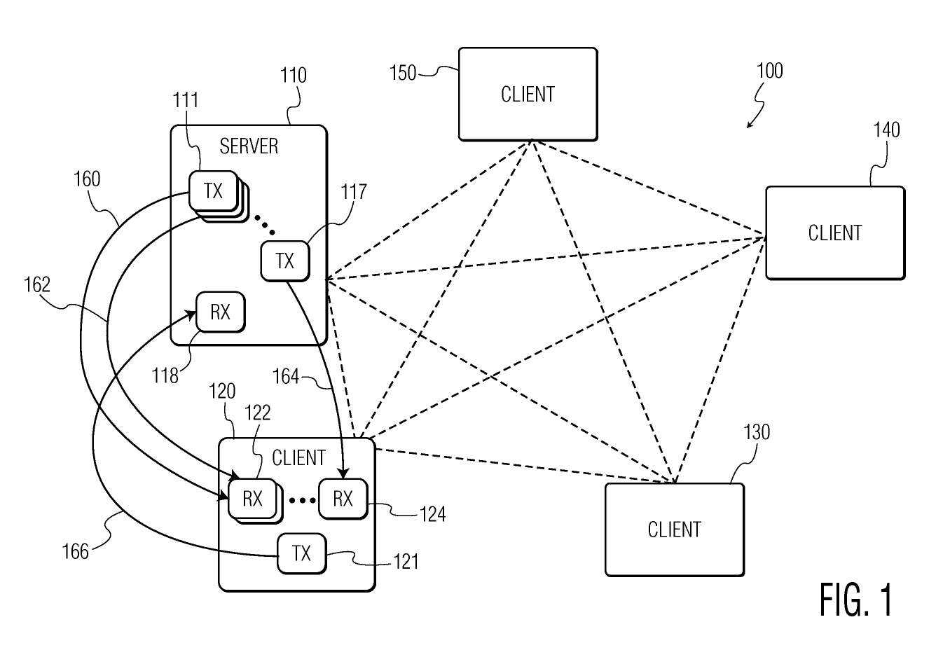

FIG. 1 shows a video distribution arrangement for wireless communications, according to an example embodiment of the present invention; and

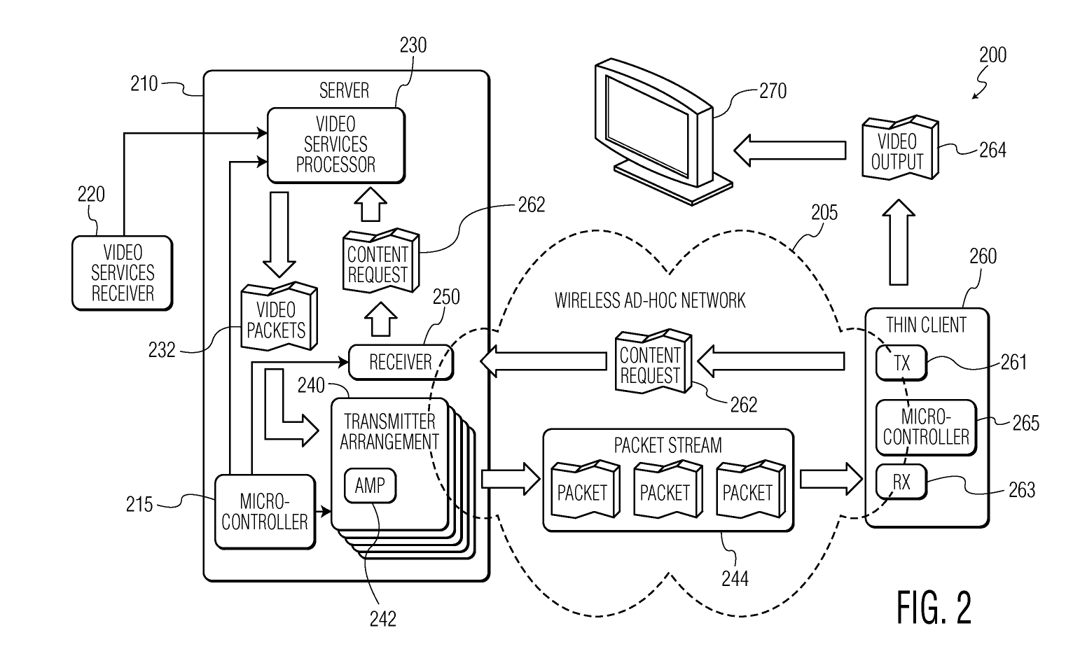

FIG. 2 shows a system for communicating video services content directly from a server to one of a plurality of thin clients over an ad-hoc network, according to another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined in the claims.

The present invention relates to systems and methods for distributing video in a closed environment, in a manner that is relatively simple and economical to implement. While the present invention is not necessarily limited to such approaches, various aspects of the invention may be appreciated through a discussion of examples using these and other contexts.

In connection with various example embodiments, a wireless video distribution approach involves processing video at a video server and wirelessly transmitting video packets directly to a remote (thin) client device over a wireless ad-hoc network. The remote client receives the wirelessly-transmitted video packets and outputs video, from the packets, to a display device such as a video monitor or television. The wireless ad-hoc network includes one or more remote clients and one or more servers, and the server or servers may also act as a client.

Client-server communications are carried out using a wireless communications protocol that is amenable for transmitting relatively high bandwidth signals, such as for streaming high-bandwidth or high-definition video (e.g., at a data rate of over 20 Mbit/s), as well as for ad-hoc wireless communications. The clients can output video corresponding to the transmitted signals in real time as the signals are received (e.g., with little or almost no buffering), in accordance with the robust and reliable nature of the ad-hoc communications.

The server and clients are implemented with asymmetrical wireless communications circuits, in accordance with data flow that is largely from server to client. In this context, the embodiments described herein can be implemented in accordance with one or more aspects of IEEE (Institute of Electrical and Electronics Engineers) 802.11a, 802.11b, 802.11 g, and 802.11n standards. In many applications, wireless communications are carried out using a hybrid standard, involving the use of IEEE 802.11n packet transfer approaches to ensure reliable video communications (e.g., for high-definition video), and using ad-hoc communications as used in earlier standards such as IEEE 802.11b. Such an approach thus involves the use of a hybrid-type communications standard. In connection with these and other embodiments, it has been discovered that such a hybrid-standard type approach is amenable to video distribution in a closed-type environment, to facilitate secure wireless communications of video data that is sufficiently robust to handle high-definition (high-bandwidth) video.

Video that is to be provided to each client is selected and/or requested in one or more of a variety of manners. Clients may request video directly from the server using the wireless ad-hoc network to communicate the video request. In such applications, each client has at least one transmitter to transmit a video request to a server. Such an approach may involve, for example, processing user video or television channel selections received at the client from a user-implemented remote control or other type of interface device. The client communicates received selections to the server, which in turn responds by streaming corresponding video to the client.

In other implementations, the server controls the delivery of video based upon programming or other characteristics that are predefined or otherwise received at the server. For example, the server may receive inputs directly from a user interface device, such as a remote control device, operated by a user wishing to view video at a client location. Such an approach is amenable, for example, to the use of radio-frequency remote controls to input a channel selection to a server that processes cable or satellite television, and that is responsive to the inputs by streaming video to a client for displaying a selected channel or other video. In this context, video requests can be effected at the server, at the client, or at both the server and the client.

The video may be sourced from one or more of a variety of types of video sources, such as from a cable, satellite or terrestrial television source, from the Internet, or from locally-stored video such as content recorded at the server or otherwise accessible to the server from an external storage device such as a digital video recorder or DVD recorder. In many applications, the server processes video packets by generating packets from video data that is received from one or more video sources. In other applications, the server processes video packets by receiving and re-transmitting video packets.

In connection with these and other example embodiments discussed herein, the video data may include a variety of types of data in addition to video (image) data. For instance, the video data may include audio data, metadata, multi-channel data (e.g., for picture-in-picture display), telephony data or other types of data as appropriate.

In certain embodiments, the server sends video data to clients for displaying control or other options to users viewing video at the client (i.e., at a video display including and/or coupled to the client). For example, the video data may include information for displaying a list of available video content selections, such as television channels, video-on-demand selections, movies, or pay-per-view video selections. The video data may also include information for displaying configuration choices, such as those relating to the format of video to be transmitted to the client.

The server processes video in one or more of a multitude of manners, which may depend upon the source format of the video, characteristics of the video, characteristics of the client (and/or accompanying video display) to which the video is sent, or characteristics of the intended use of the video. In some applications, the server transmits sourced video to a remote client device in a format as provided by or retrieved from a video source, effectively receiving and re-transmitting the video. In other applications, the server processes the sourced video, such as by decompressing and/or decrypting the video, extracting a portion of the video, or by packetizing the video, prior to transmitting the packets to a remote client.

In certain embodiments, the server provides multiple data streams to suit the needs of one or more clients. For instance, separate data streams may be provided for displaying two different video sources. One approach involves transmitting separate video packet streams for displaying more than one television channel (e.g., for picture-in-picture or side-by-side display). Another approach involves transmitting an accompanying audio stream for playback with video data in a video packet stream. Still another approach involves transmitting a data packet stream including information for displaying together with and/or overlaid upon video that is displayed. Still another approach involves transmitting configuration, encryption or other processing data that is used at the client to process and/or display video in received packet streams.

In connection with more specific example embodiments, a wireless video distribution approach involves generating a video packet stream from an incoming video services signal (e.g., a television signal) received at a video server, and securely transmitting the packet stream to a remote client device over a wireless ad-hoc network. Generating such a packet stream from an incoming video services signal may, for example, involve extracting a high bandwidth television channel from the incoming signal (e.g., a high-definition television channel) in response to inputs received from a user via the remote client or otherwise. The remote client device receives the packet stream and generates a video output signal amenable for use by a video display such as a television (e.g., the remote client generates a digital and/or analog video signal, and where appropriate, an accompanying audio signal present in the packet stream).

This approach is useful, for example, for distributing video in a network environment without necessarily implementing a wireless access point or other central-type connection point, which can reduce the complexity of the system, reduce cost and further reduce the number of communication hops between devices (i.e., communication is directly between the server and client). This approach is also amenable for use with wireless communications protocols necessary to implement high-bandwidth streaming, such as the IEEE 802.11n protocol, with the server and clients being programmed to implement ad-hoc communications associated with other protocols in order to deliver packets generated in accordance with the 802.11n protocol.

Secure transmission in accordance with the various embodiments discussed herein is effected using one or more of a variety of approaches. In some implementations, the wireless network is secure, using one or more types of secure wireless transmission approaches to ensure data sent from the server to the client is secure. This approach is useful, for example, in applications where it is desirable to remove protection measures from video services content at the server, and to transmit unprotected video data to a client. In other implementations, the packet stream transmitted from the server to the client is secure (e.g., via encryption), and the client is programmed or otherwise operates to process the secure packet stream for use at an accompanying video display. Where the packet stream is secure, the wireless network may or may not be secure, depending upon the application.

Turning now to the figures, FIG. 1 shows a system 100 for distributing high-bandwidth video, according to another example embodiment of the present invention. The system 100 includes a video server 110 that receives a video signal and redistributes the signal to one of clients 120, 130, 140 and 150 over a wireless ad-hoc network. The ad-hoc network is represented by dashed lines, with each client communicating with the server 110. The ad-hoc network may also involve communication between clients.

The server 110 has multiple transmitters 111-117 for transmitting signals to the clients 120-150, and at least one receiver 118 for receiving video requests from the clients. Each of the clients 120-150 has at least one receiver for receiving video data from the server 110, and a transmitter for transmitting video requests and/or other information as appropriate to the server 110. In various applications, the server 110 is also a client and receives information from another server. In addition, while shown with one server and four clients, the system 100 may be implemented with two or more servers, such as in applications involving one of the clients 120-150 also acting as a server.

The video request data may include one or more of a variety of types of data, and may specify video data obtained via subscription to a multi-cast stream, RTP (real-time transfer protocol), RTSP (real-time streaming protocol), http-get (hypertext transfer protocol get), or otherwise. The transmitter at each client effectively requests the data to be sent as one or more streams in a particular transport protocol.

By way of example, client 120 is shown having a transmitter 121 and receivers 122-124. In this regard, while the server 110 has relatively robust network communications circuitry (i.e., multiple transmitters, each having an amplifier and related circuitry), each of the clients 120-150 can have relatively thin communications capability, and can operate with a single amplifier for transmitting what can be relatively simple and low-bandwidth requests to the server 110. With this approach, the system 100 can be implemented relatively simply and economically, as with this server/client relationship, most of the data flows in from the server 110 to the clients 120-150.

Each receiver supports the target transport protocol used in sending data between the client and server. The received data may include, for example, one or more independent streams, such as independent audio and data elementary streams, a multiplexed stream for content and metadata associated with the content (e.g., a MPEG2 program stream), one or more multiplexed streams that include a plurality of program streams (e.g., an MPEG2 transport stream), or a combination of types of streams. Streams received at one of the clients 120-150 may, for example, be used to display more than one video stream for uses such as picture-in-picture, live viewing of one stream while recording one or more additional streams, or communicating non-real-time data such as advertising data.

In some applications, the server 110 communicates over multiple communications paths to different receivers at a particular one of the clients. Referring to client 120 by way of example, the server may transmit packet streams over separate channels 160, 162 and 164, in response to requests received from the client 120 on channel 166. As discussed herein, the server 110 may use the different channels 160, 162 and 164 to communicate different types of information, such as video on one channel, corresponding audio on another channel, and services information on another channel.

In some embodiments, video data is communicated on more than one channel. This approach can be used to facilitate the transmission of two or more video services signals, such as for displaying two television channels at the client 120. This approach may also be used to facilitate the transmission of a single video feed, such as a television channel or movie, over two different channels. Multi-channel transmission of a single video feed can be useful, for example, to facilitate the delivery of high-bandwidth signals (e.g., packets can be transmitted over two channels and assembled at the client), or to provide a backup video stream (e.g., when wireless communications are susceptible to interruption or communications errors).

The system 100 may be configured using a variety of approaches. In some embodiments, each of the clients 120-150 default to a pre-defined, common installation network upon initiation (e.g., defined by a SSID (service set identifier), WEP (wired equivalent privacy) key, and channel). The clients receive operational network information from the server 110. The server 110 selects a likely unique network based on properties of the server (e.g., MAC address, HDD serial-number, FLASH GUID, or similar) to define the network settings. The clients then reconfigure themselves onto the new network and await rediscovery of the server on the operational network. After an event such as a timeout, limit of clients discovered, or user interruption, the server 110 reconfigures local wireless communications to the operational network and starts a client discovery process to discover each client on the operational network. The server 110 and clients 120-150 are now ready to operate, and the server may discover clients to enable discovery of additional clients without changing the state of any previously discovered devices. The clients can return to a factory default state in order to repeat acquisition in case of an error.

Once the server 110 and clients 120-150 are communicating on an operational network in accordance with the above, and in accordance with various example embodiments, the network is switched to operate in an infrastructure mode, using a device (e.g., the server 110) as an access point. In this manner, devices on the closed system, such as the clients 120-150, can be connected to an open-network and gain access to other Ethernet devices in a closed environment such as in a user's home.

The server 110 can provide video data that is sourced from one or more of cable, satellite or terrestrial feeds, such as DVB-T, DVB-T2, DVB-C, DVB-S, DVB-S2, or one or more other satellite channels. The server 110 may also provide video data that is sourced from the Internet or a local storage device. For Internet feeds, the server 110 can be implemented as a multi-homed sever that connects to the Internet on an Ethernet port and that connects to the ad-hoc network on a second and independent wireless Ethernet port. In certain embodiments where two or more of the clients 120-150 subscribe to or request the same video data, the server 110 implements an IP broadcasting approach such as UDP (user datagram protocol)-based transport to carry out similar actions for a plurality of clients.

The server 110 can process sourced video data that may or may not be encrypted, and does so in one or more of a variety of manners in connection with various example embodiments. In various embodiments, the server 110 forwards encrypted data in its original form to clients, transmits unencrypted data to clients, and/or decrypts and re-encrypts data using a different encryption approach (e.g., a different digital rights management (DRM)-scheme).

In a particular embodiment, the server 110 receives a satellite, cable or terrestrial television feed and that is protected via conditional access. The server 110 is configured to decrypt received video data, where the clients 120-150 may not have such decryption capability, and the server then re-encrypts the data using an approach such as DTCP-IP (digital transmission content protection over Internet protocol) before forwarding the data to a client or clients.

In another embodiment, the server 110 receives content and stores the received content using WMDRM-PD (Windows media DRM for portable devices). The server 110 then re-encrypts the data using WMDRM-NDT (WMDRM for a network device, transmitter) for transmission to one of the clients 120-150 employing WMDRM-NDR (WMDRM for a network device, receiver).

In some embodiments, the present invention is implemented using existing equipment, thereby expanding the usage of existing systems while saving costs. For example, a client device such as a computer may receive a signal from a server that is implemented to process high-definition video (e.g., a digital satellite receiver) and to communicate the high-definition video using a robust protocol (e.g., IEEE 802.11n) modified for operation in ad-hoc mode (e.g., as with IEEE 802.11b).

FIG. 2 shows a system 200 for communicating video services content directly from a server 210 to one of a plurality of thin clients over an ad-hoc network 205, according to another example embodiment of the present invention. The server 210 receives video content from a video service, such as a satellite or cable service that is received at a video services receiver 220, and communicates video data corresponding to the video content to one of a plurality of thin clients requesting content. The server 210 includes a video services processor 230 that processes received video service data and provides video packets 232, from the video service data, to a transmitter arrangement 240. A microcontroller 215 controls the operation of the transmitter 240 and receiver 250, for communicating in accordance with an appropriate ad-hoc protocol, and further controls the video services processor 230 for providing packets to facilitate high-bandwidth video communications, such as for high-definition video.

The transmitter arrangement 240 amplifies (at 242) and sends a packet stream 244 to one of a plurality of thin clients, with a thin client 260 shown by way of example. The example thin client 260 includes a transmitter 261 and a receiver 263, respectively for transmitting a content request 262 and for receiving a packet stream 244 in response to the request. A microcontroller 265 controls the transmitter 261 and receiver 263, for communicating in accordance with an ad-hoc communications protocol.

The video services processor 230 is responsive to the content request 262, which is received at receiver 250, to provide the packet stream 244. The thin client 260 provides a video output 264 for displaying video in the packet stream 244 on a display 270, such as a television. In some applications, the thin client 256 is integrated with the video display 270.

According to various embodiments, the video services processor 230 provides received video services data directly as a pass-through to clients, or processes the data in accordance with one or more of a variety of approaches such as described above. For example, an incoming video services stream may be processed for decryption, encryption, channel extraction, multiplexing, protocol compliance (e.g., IEEE 802.11n), or for other purposes.

In addition to the above, the various processing approaches described herein can be implemented using a variety of devices and methods including general purpose processors implementing specialized software, digital signal processors, programmable logic arrays, discrete logic components and fully-programmable and semi-programmable circuits such as PLAs (programmable logic arrays). For example, the above algorithms are executed on a microcomputer (a.k.a. microprocessor) in connection with certain embodiments, and as may be implemented as part of one or more of the devices shown in the figures.

While the present invention has been described above, in the figures and in the claims that follow, various systems and approaches may be implemented in connection with and/or in addition to the example embodiments described above. For instance, embodiments described in reference to the figures may be implemented using different systems and approaches. Embodiments described without specific reference to the figures may be implemented with the figures. In this regard, those skilled in the art will recognize that many changes may be made thereto without departing from the spirit and scope of the present invention.

What is claimed is:

1. A video distribution system for direct server-client streaming of high-bandwidth video data over a wireless ad-hoc network, the system comprising:
a plurality of clients, each client including
a transmitter to transmit video request data directly to a video server on the network in accordance with an ad-hoc communications protocol,
a plurality of receivers to receive streaming video over the network,
a microcontroller programmed to control communications via the transmitter and receivers in accordance with an ad-hoc, high-bandwidth protocol, and
a video output circuit to output, to a display device, video corresponding to the received video stream; and
a video server arrangement including
a receiver to receive video request data directly from the clients,
a video processing circuit to access video in response to video request data from the clients,
a plurality of transmitters to stream accessed video over the network and directly to one of the clients requesting the accessed video, and
a microcontroller programmed to control communications via the receiver and transmitters in accordance with an ad-hoc, high-bandwidth protocol.

2. The system of claim 1, wherein each client includes only one transmitter.

3. The system of claim 1, wherein
the server streams high-bandwidth video, having a bit rate of at least about 20 Mbit/s, directly to a particular one of the clients over the network, and
the particular client receives the high-bandwidth video and outputs the video to a video display device in real time as the video is received.

4. The system of claim 1, wherein
the video server is adapted to stream multiple streams of data directly to a single one of the clients, and
the single client is adapted to simultaneously receive the multiple streams of data from the video server.

5. The system of claim 1, wherein
the video server is adapted to stream a multiplexed video data stream directly to a single one of the clients, and
the single client is adapted to receive and de-multiplex the multiplexed video data stream.

6. The system of claim 1, wherein
the video server is adapted to stream video corresponding to at least two different video sources directly to a single one of the clients, and
the single client is adapted to simultaneously receive the video corresponding to at least two video sources and to output video for simultaneously displaying images from each of the at least two different video sources.

7. The system of claim 1, wherein
the video server is adapted to stream separate packet streams for audio, video and data directly to a single one of the clients, and
the single client is adapted to simultaneously receive and process the packet streams for outputting audio and video to the video display, in accordance with the data.

8. The system of claim 1, wherein the video processing circuit accesses video by receiving an encrypted video stream from a video services provider and processing the accessed video for transmission to one of the clients.

9. The system of claim 1, wherein the video processing circuit accesses video by receiving an encrypted video stream from a video services provider, decrypting the encrypted video stream, re-encrypting the video stream for transmission on the network, and transmitting the re-encrypted video stream to one of the clients.

10. A video services distribution system for direct, server-client streaming of video data over a wireless ad-hoc network, the system comprising:
a plurality of clients, each client including
a transmitter to transmit video services request data directly to a video server on the network in accordance with an ad-hoc communications protocol,
a plurality of receivers to receive streaming video services data over the network,
a microcontroller programmed to control communications via the transmitter and receivers in accordance with an ad-hoc, high-bandwidth protocol, and
a video output circuit to output, to a display device, video including high-definition video corresponding to the received video stream; and
a video server arrangement including
a receiver to receive video services request data directly from the clients,
a video processing circuit to access and process video content from a video service provider, in response to video request data from the clients,
a plurality of transmitters to stream the accessed and processed video content over the network and directly to one of the clients requesting the accessed video content, and
a microcontroller programmed to control communications via the receiver and transmitters in accordance with an ad-hoc, high-bandwidth protocol.

11. The system of claim 10, wherein
each of the clients is programmably configured to establish an initial, ad-hoc, peer-to-peer communication link with the server over a wireless installation network;
the server is responsive to communications from a client over the installation network by communicating network connection data to the client over the installation wireless network, the network connection data including information for communicating directly with the server over the network; and
each of the clients is responsive to the network connection data by establishing ad-hoc communications with the server over the network.

12. The system of claim 10, wherein
the network is a secure network that is compliant with IEEE standard 802.11n, and
the plurality of transmitters stream the extracted video directly to each of the clients in accordance with IEEE standard 802.11n packet standards, using an ad-hoc communication approach.

13. The system of claim 10, wherein
the secure network is a network that operates in accordance with a hybrid wireless protocol that is compliant with a first protocol supporting ad-hoc communications and with a second protocol that supports the communication of high-bandwidth video data,
the server includes a chipset configured for ad-hoc communications in accordance with the first protocol, for generating video packets from the accessed and processed video content in accordance with the second protocol, and for streaming the generated video packets directly to one of the clients over the secure network in accordance with ad-hoc communications for which the chipset is configured.

14. The system of claim 10, wherein
the video processing circuit accesses and processes video content from a video services provider by extracting a program from a transport stream including multiple programs, and
the transmitters transmit a program stream, extracted by the video processing circuit, directly to one of the clients.

15. The system of claim 10, wherein
the video processing circuit accesses and processes video content from a video services provider by accessing a transport stream including multiple programs,
the transmitters transmit the accessed transport stream directly to one of the clients, and
the client receiving the accessed transport stream is programmed to generate and output video corresponding to a program in the transport stream.

16. The system of claim 10, further including a video display device that includes one of the clients and is adapted to display video content received by the one of the clients.

17. The system of claim 10, wherein the server and clients have asymmetrical transmitter and receiver combinations, with the server having more transmitters than receivers and the clients having only one transmitter and at least two receivers.

18. The system of claim 10, wherein at least one of the server and the clients is adapted to communicate on both the ad-hoc network and a different infrastructure network.
